(19) United States
(12) Patent Application Publication
(10) Pub. No.: US 2007/0035882 A1
(43) Pub. Date: Feb. 15, 2007

(54) FLOATING THIN-FILM MAGNETIC HEAD HAVING CROWN SERVING AS MEDIUM-FACING SURFACE AND METHOD FOR PRODUCING THIN-FILM MAGNETIC HEAD

(75) Inventors: Akio Kishimoto, Niigata-ken (JP); Masamitsu Senuma, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/460,147

(22) Filed: Jul. 26, 2006

(30) Foreign Application Priority Data
Aug. 10, 2005 (JP) 2005-232353

(51) Int. Cl. G11B 5/60

(52) U.S. Cl. 360/235.4

(57) ABSTRACT

A floating thing-film magnetic head and method of producing the same is provided. A floating thin-film magnetic head includes a slider that is floated from a surface of a rotating recording medium by airflow generated over the surface of the recording medium. A thin-film magnetic head element formed on an air-outflow end surface of the slider. A crown is formed on a medium-facing surface formed of the bottom surfaces of the slider and the thin-film magnetic head element that protrudes in a section that includes an air-inflow end and an air-outflow end of the slider. The crown includes a large-diameter crown with a large curvature radius that forms a central portion of the medium-facing surface that excludes the air-inflow end and the air-outflow end. A small-diameter crown forms portions of the medium-facing surface that correspond to the air-inflow end and the air-outflow end.

This application claims the benefit of Japanese Patent Application No. 2005-232353 filed Aug. 10, 2005, which is hereby incorporated by reference.

### BACKGROUND

1. Field

A floating thin-film magnetic head and method for producing the same is provided.

2. Related Art

A floating thin-film magnetic head includes a slider into which a magnetoresistive element or an inductive element is incorporated, a flexure having the slider bonded to a free end thereof and composed of flexible sheet metal, and a load beam to which the flexure is fixed. When movement of a recording medium is stopped, the bottom surface of the slider is in contact with the surface of the recording medium by the elastic force of the load beam. When movement of the recording medium is started, airflow is introduced between the slider and the surface of the recording medium along a moving direction of the recording medium, and the slider is floated from the surface of the recording medium by the action of lift force caused by the airflow. The thin-film magnetic head conducts reading-writing operations while the slider is floated.

The slider includes a reading element portion and a writing element portion deposited at an air-outflow end surface thereof. The reading element portion includes a magnetoresistive element whose resistance varies in response to the strength of an external magnetic field and electrode layers that energize the magnetoresistive element. The writing element portion includes lower and upper core layers that are magnetically connected to each other at a position remote from a surface that faces the recording medium (hereinafter referred to as a medium-facing surface), which are deposited such that a magnetic gap layer is interposed therebetween, and a coil layer that applies a writing magnetic field to the upper and lower core layers.

In general, the reading element portion and the writing element portion are covered with a protective layer composed of insulating materials such as A1₂O₃. The thin-film magnetic head conducts the reading operation by detecting changes in the resistance of the energized magnetoresistive element, and conducts the writing operation by generating an induced magnetic field in the lower core layer and the upper core layer by applying current to the coil layer, and by applying a magnetic field leaked from the magnetic gap layer to the recording medium as the writing magnetic field.

During reading and writing operations of the thin-film magnetic head, the temperature of the reading element portion rises according to the current passing through the magnetoresistive element, and the temperature of the writing element portion rises according to the coil layer that generates heat due to the current passing through the coil layer. The reading element portion and the writing element portion are covered with the protective layer composed of insulating materials. The heat of these element portions is difficult to release outward, and the element portions becomes hot. The temperature rise in the element portions causes thermal expansion of the element portions and protrusion from the medium-facing surface. In order to prevent the thin-film magnetic head from coming into contact with the recording medium, various measures have been taken. For example, the element portions of the thin-film magnetic head has been obliquely ground or a cutoff portion is formed at an end of the element portions of the thin-film magnetic head (see Japanese Unexamined Patent Application Publication Nos. 10-49822 and 2000-153452).

However, the lift of the thin-film magnetic head with respect to the recording medium has been required to be set to about 10 nm or lower recently in response to the need for higher recoding density of the recording medium. When the lift is extremely small as described above, the contact of the element portions, which protrude from the medium-facing surface due to the thermal expansion, with the recording medium is significantly difficult to avoid, and the risk of damage to the recording medium, magnetic information written in the recording medium, or the element portions is further increased. The frequencies of the current applied to the magnetoresistive element and the coil layer are increased for higher recording density, and thus the temperature of the writing element portion, in particular, often exceeds 100° C., resulting in large protrusion of the writing element portion. Thus, errors in grinding the element portions of the thin-film magnetic head or in forming the cutoff portion in the element portions according to the known measures exert a large influence on the lift due to the extremely small target lift of the head. This causes wide variation among individual heads, and control of the heads becomes difficult.

### SUMMARY

By focusing on the distance between a thin-film magnetic head element formed on an air-outflow end surface of a slider and the recording medium can be appropriately retained for avoiding contact by forming a large convex crown and a small convex crown in two phases on a medium-facing surface formed of the bottom surfaces of the slider and the thin-film magnetic head element.

The floating thin-film magnetic head includes a slider that is floated from a surface of a rotating recording medium by airflow generated over the surface of the recording medium. A thin-film magnetic head element is formed on an air-outflow end surface of the slider. A crown is formed on a medium-facing surface formed of the bottom surfaces of the slider and the thin-film magnetic head element so as to protrude in a section that includes an air-inflow end and an air-outflow end of the slider. The thin-film magnetic head is characterized in that the crown includes a large-diameter crown with a large curvature radius that forms a central portion of the medium-facing surface that excludes the air-inflow end and the air-outflow end, and a small-diameter crown forming portions of the medium-facing surface corresponding to the air-inflow end and the air-outflow end.

According to a preferred embodiment, the method that produces a thin-film magnetic head includes a step of forming a thin-film magnetic head element on an air-outflow end surface of a slider that is floated from a surface of a rotating recording medium by airflow generated over the surface of the recording medium, and a step of lapping for forming convex crowns on a medium-facing surface formed of the bottom surfaces of the slider and the thin-film magnetic head element in two phases. The method for producing a thin-film magnetic head is characterized in that the step of lapping performed in the two phases includes a first lapping step for forming a first crown in a section including an air-inflow end and an air-outflow end of the slider, and a second lapping step for forming a second convex crown in the section including the air-inflow end and the air-outflow end of the slider on the same medium-facing surface in random order. The radii of the first crown and the second crown are different from each other.

Specifically, the step of lapping performed in the two phases includes the first lapping step that forms the first convex crown that has a large curvature radius on the medium-facing surface in the section including the air-inflow end and the air-outflow end of the slider. The second lapping step forms the second convex crown that has a small curvature radius on the same medium-facing surface in the section that includes the air-inflow end and the air-outflow end of the slider such that the distance between the thin-film magnetic head element having the second crown and the recording medium is larger than the distance between the thin-film magnetic head element having the first crown and the recording medium, the first lapping step and the second lapping step being performed in any order.

In general, the thin-film magnetic head includes a reading element portion and a writing element portion deposited in this order from the slider.

The first and second lapping steps are performed on a bar having a plurality of sliders and thin-film magnetic head elements.

A thin-film magnetic head capable of improving the reliability of the head by appropriately retaining a small lift such that the contact with the recording medium during reading-writing operations is prevented and adaptable to higher recording density, and a method for producing the same can be achieved by a simple and stable step of forming crowns having large and small curvature radii on the medium-facing surface of the slider.

The preferred embodiments provide a thin-film magnetic head capable of improving the reliability of the head by appropriately retaining a small lift such that the contact with the recording medium during reading-writing operations is prevented and adaptable to higher recording density, and a method that produces the same.

### DRAWINGS

FIG. 1 is an overall plan view that illustrates a thin-film magnetic head;

FIG. 2 is a side view of a floating slider including a thin-film magnetic head element in the thin-film magnetic head shown in FIG. 1;

FIG. 3 is a cross-sectional view that illustrates the layered structure of the thin-film magnetic head element sectioned at the center of the element; and

FIG. 4 is a schematic view that illustrates an example of a method that produces the thin-film magnetic head.

### DESCRIPTION

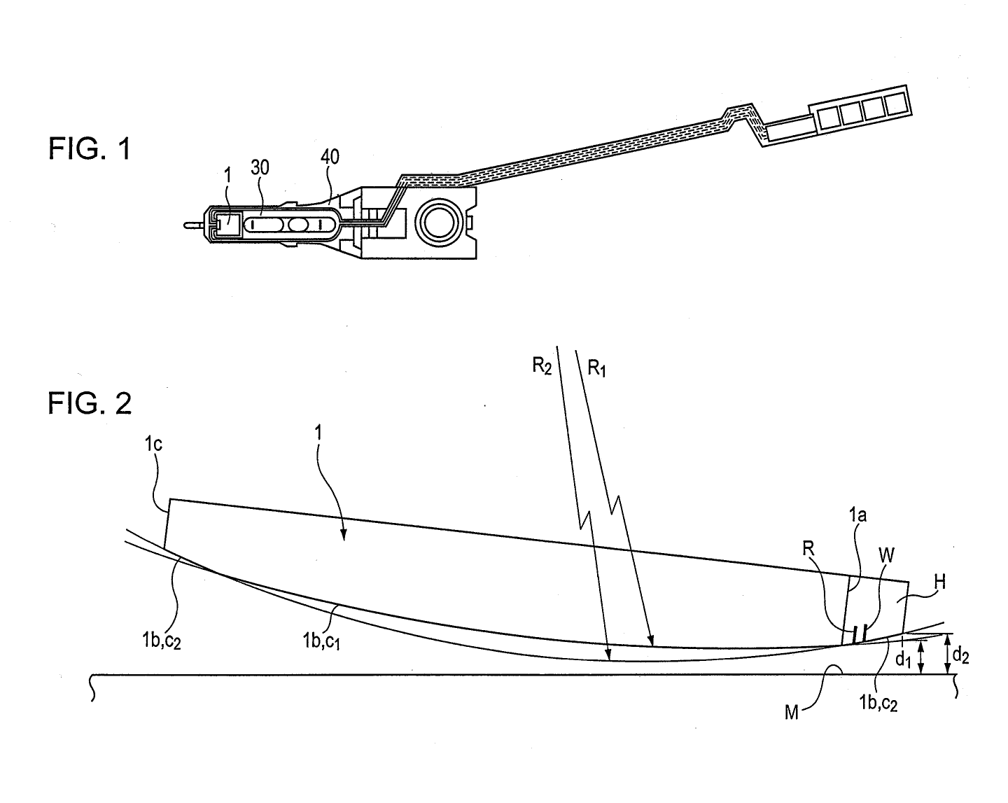

FIG. 1 is an overall plan view that illustrates a thin-film magnetic head according to the present invention. The thin-film magnetic head includes an approximately rectangular floating slider 1 composed of for example A1₂O₃−TiC. A flexure 30 that has the slider 1 bonded to a free end thereof and is composed of flexible sheet metal. The flexure 30 is fixed to a load beam 40 .

When movement of a recording medium M (see FIG. 2) is stopped, the bottom surface of the slider 1 (medium-facing surface) is in contact with the surface of the recording medium by the elastic force of the load beam 40. When movement of the recording medium is started, airflow is introduced between the slider 1 and the surface of the recording medium along a moving direction of the recording medium, and the slider 1 is floated from the surface of the recording medium by the action of lift force caused by the airflow. The thin-film magnetic head conducts reading-writing operations while the slider is floated.

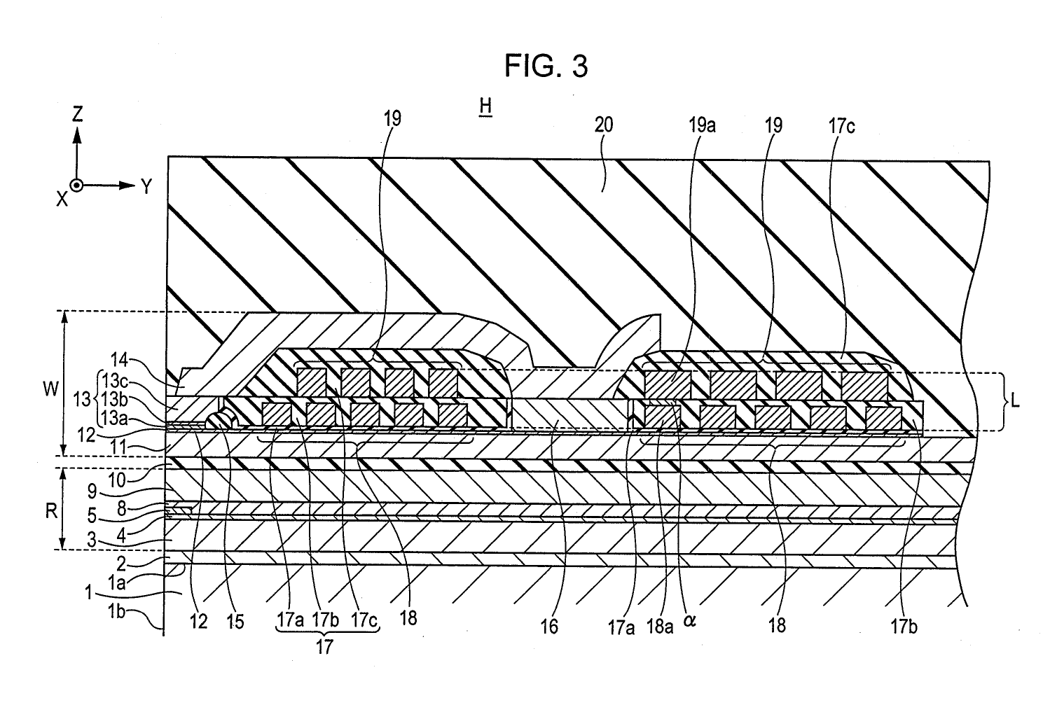

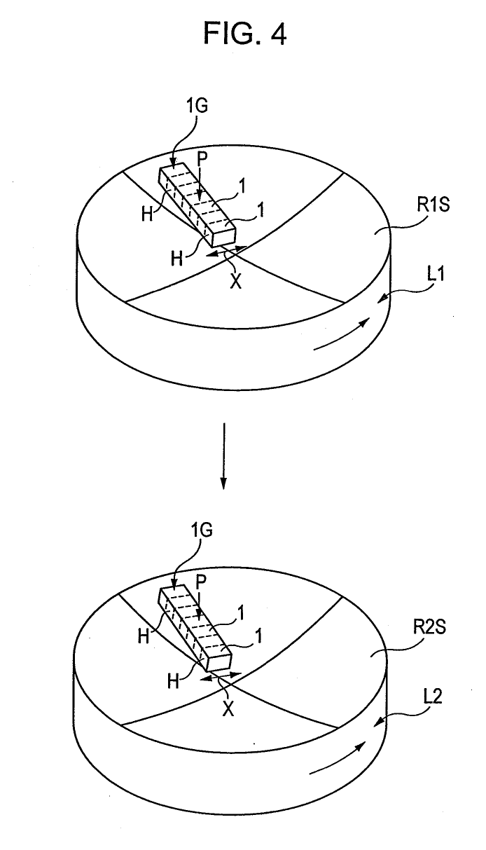

As shown in FIG. 2, the thin-film magnetic head is of a reading-writing type that includes a thin-film magnetic head element H (a reading element portion R and a writing element portion W) formed at an air-outflow end surface 1a of the slider 1. An air-inflow end surface 1c is disposed at the opposite side of the air-outflow end surface 1a. FIG. 3 is a cross-sectional view that illustrates the layered structure of the thin-film magnetic head element H sectioned at the center of the element including the air-inflow end surface 1c and the air-outflow end surface 1a. In FIG. 3, the X, Y, and Z directions correspond to a width direction of tracks, a depth direction (height direction) of the tracks, and a stacking direction of layers of the thin-film magnetic head element H.

The reading element portion R includes a lower shielding layer 3, a lower gap layer 4, a magnetoresistive element 5, an upper gap layer 8, and an upper shielding layer 9 deposited in this order from an undercoat 2. The lower shielding layer 3 and the upper shielding layer 9 are composed of soft magnetic materials, for example, Ni−Fe. The lower gap layer 4 and the upper gap layer 8 are composed of nonmagnetic materials, for example, A1₂O₃. The magnetoresistive element 5 is a giant magnetoresistive (GMR) element typified by a spin-valve film, an anisotropic magnetoresistive (AMR) element, or a tunnel magnetoresistive (TMR) element. Although not shown, bias layers composed of ferromagnetic materials, for example, Co−Pt alloys and a pair of electrode layers composed of good conductive materials, for example, Au connected to the magnetoresistive element 5 are formed on the lower gap layer 4 at either side of the magnetoresistive element 5 in the X direction in the drawing. The upper gap layer 8 and the upper shielding layer 9 are disposed on the magnetoresistive element 5. As shown in FIG. 3, each end of the layers of the reading element portion R (the lower shielding layer 3, the lower gap layer 4, the magnetoresistive element 5, the upper gap layer 8, and the upper shielding layer 9) is exposed to a medium-facing surface 1b formed of the bottom surfaces of the slider 1 and the thin-film magnetic head element H. The thin-film magnetic head element H conducts a reading operation by applying a constant current to the magnetoresistive element 5, and by reading the change in the resistance of the magnetoresistive element 5 with respect to an external magnetic field as a change in voltage.

An insulating layer 10 composed of insulating materials, for example, Al₂O₃ is disposed on the upper shielding layer 9 serving as the uppermost layer of the reading element portion R. The writing element portion W is deposited on the reading element portion R via this insulating layer 10.

The writing element portion W includes a lower core layer 11, a primary plating layer 12, and a writing core portion 13 facing the medium-facing surface 1b and deposited in this order from the insulating layer 10. The writing element portion W further includes an upper core layer 14 that is deposited on the writing core portion 13 and is not exposed to the medium-facing surface 1b. An insulating layer 15 determines a gap depth (Gd) composed of organic insulating materials such as a resist. A magnetically connecting portion 16 magnetically connects the lower core layer 11 and the upper core layer 14 having the primary plating layer 12 interposed therebetween. A coil layer L is embedded in an insulating layer 17. The lower core layer 11 and the upper core layer 14 are formed of magnetic films, for example, permalloys, Co alloys, and Fe alloys. The primary plating layer 12 is composed of conductive materials.

The writing core portion 13 is a three-layered structure having a lower magnetic layer 13a that is magnetically connected to the lower core layer 11 via the primary plating layer 12. A gap layer 13b is composed of nonmagnetic materials. An upper magnetic layer 13c is magnetically connected to the upper core layer 14. The lower magnetic layer 13a and the upper magnetic layer 13c are composed of magnetic materials, for example, permalloys, Co alloys, and Fe alloys. The saturation flux density of the magnetic materials is preferably higher than that of the lower core layer 11. A primary insulating sublayer 17a and a first coil insulating sublayer 17b, which are part of the insulating layer 17, cover either end of the writing core portion 13 in the track-width direction.

The insulating layer 15 determines the gap depth disposed at a position remote from the medium-facing surface 1b in the depth direction by a predetermined distance so as to define the size of the gap layer 13b of the writing core portion 13 in the depth direction. The gap depth of the thin-film magnetic head element H is defined by the distance from the medium-facing surface 1b to the leading end of the insulating layer 15 that determines the gap depth. The magnetically connecting portion 16 is composed of magnetic materials, for example, permalloys, Co alloys, and Fe alloys.

The insulating layer 17 includes the primary insulating sublayer 17a that covers the upper magnetic layer 13c, the insulating layer 15 determines the gap depth, the primary plating layer 12, and the magnetically connecting portion 16 at either end in the track-width direction. The first coil insulating sublayer 17b is formed on the primary insulating sublayer 17a and covers first coil sublayers 18 and intervals between adjacent pairs of the first coil sublayers 18A second coil insulating sublayer 17c is formed on the first coil insulating sublayer 17b and covers second coil sublayers 19 and intervals between adjacent pairs of the second coil sublayers 19. The above-described upper core layer 14 is formed on the second coil insulating sublayer 17c. This insulating layer 17 is composed of inorganic insulating materials, for example, A1₂O₃ and SiQ₂, or of organic insulating materials such as a resist.

The coil layer L is composed of conductive materials having low electrical resistance, for example, Cu. The coil layer L is a two-layered structure having the first coil sublayers 18 spirally wound around a winding center 18a and the second coil sublayers 19 spirally wound in a direction opposite to that of the first coil sublayers 18. The first coil sublayers 18 and the second coil sublayers 19 are connected to each other at the winding centers 18a and 19a via a contact conductor α. Although not shown, a first coil lead layer is formed at the winding end of the first coil sublayers 18. The coil layer L may be a single-layered structure or a multilayered structure having three or more layers. The thin-film magnetic head element H generates an induced magnetic field in the upper core layer 14 and the lower core layer 11 by the action of writing current passing through the coil layer L, and applies a magnetic field leaked from the gap layer 13b of the writing core portion 13 to the recording medium M as a writing magnetic field. Thus, the thin-film magnetic head element H conducts a writing operation.

A protective layer 20 is composed of insulating materials, for example, A1₂O₃, and covers the entirety of the writing element portion W and the reading element portion R.

FIG. 2 is a cross section (side shape) of the slider 1 that includes the air-inflow end and the air-outflow end thereof, the slider 1 having the thin-film magnetic head element H with the above-described structure. The medium-facing surface 1b of the slider 1 in this embodiment has a crown C1 with a large curvature radius R1 and a crown C2 with a small curvature radius R2 (R1>R2) such that the medium-facing surface 1b protrudes. The curvature radii of the crown C1 and the crown C2 are on the order of meters, the length of the slider 1 (distance from the air-inflow end to the air-outflow end) includes the thin-film magnetic head element H is on the order of millimeters, and the degree of protrusion is on the order of nanometers. However, the degree of protrusion is exaggerated in the drawing. The crown C1 is formed in the center of the medium-facing surface 1b excluding the air-inflow end and the air-outflow end. The crown C2, which has a smaller curvature radius than that of the crown C1, is formed in only the air-inflow end and the air-outflow end (including the thin-film magnetic head element H) of the medium-facing surface 1b after the formation of the crown C1 such that no influence is exerted on the center of the medium-facing surface 1b (the crown C1 is kept in the center). A distance d1 from the end of the thin-film magnetic head element H to the recording medium M when the crown C1 is formed is smaller than a distance d2 from the end of the thin-film magnetic head element H to the recording medium M when the crown C2 is formed (d2>d1). Since the reading element portion R and the writing element portion W in the thin-film magnetic head element H are disposed in this order from the air-outflow end surface 1a of the slider 1, the distance between the writing element portion W, which generates more heat than the reading element portion R, and the recording medium M can be increased. Thus, the contact between the writing element portion W and the recording medium M due to the thermal expansion of the writing element portion W can be prevented more reliably.

In general, a convex crown in a direction orthogonal to the cross section shown in FIG. 2 (cross crown) is also formed in the slider 1. However, the presence of this cross crown and the size of curvature are not at issue in this embodiment.

The above-described crowns C1 and C2 are formed using lapping plates having different curvature radii. FIG. 4 is a conceptual diagram of the lapping. These lapping plates and a crown-forming device are disclosed in Japanese Unexamined Patent Application Publication No. 2000-153452 by the inventor of the present application. A lapping plate L1 includes a concave processing surface R1S (part of a spherical surface) having a large curvature radius R1 of, for example, approximately 10 to 12 m corresponding to the crown C1. A lapping plate L2 includes a concave processing surface R2S (part of a spherical surface) having a curvature radius R2 of, for example, approximately 2 to 5 m corresponding to the crown C2, the curvature radius being smaller than that of the lapping plate L1.

As is generally known, a large number of sliders 1 having thin-film magnetic head elements H are simultaneously formed on a wafer using thin-film deposition technology. A bar 1G shown in FIG. 4 is cut from the wafer such that the bar 1G includes a line of thin-film magnetic head elements at a side surface thereof. The air-inflow ends and the air-outflow ends are disposed along a direction (X) orthogonal to a lengthwise direction of the bar 1G.

This bar 1G is disposed such that the lengthwise direction thereof corresponds to the radial direction of the rotating lapping plate L1, and is pressed against the processing surface R1S with an appropriate force P for a predetermined period of time for a first lapping. After the first lapping is finished, the bar 1G is moved to the processing surface R2S of the lapping plate L2, and is lapped in the same manner. The order of the first and second lappings may be changed.

After the first and second lappings of the bar 1G, the bar 1G is cut at each of the thin-film magnetic head elements H. Thus, a slider 1 having a thin-film magnetic head element H is obtained.

The numerical values of the crown C1 (curvature radius R1) and the crown C2 (curvature radius R2) in the description above are merely examples. The distance d2 (see FIG. 2) between the surface of the recording medium and the thin-film magnetic head element H, which is further from the surface of the recording medium than the slider 1, is set such that a target lift (the distance from the surface of the recording medium) is obtained when the thin-film magnetic head element H is thermally expanded by the passage of current.

In this embodiment, the present invention is applied to a reading-writing thin-film magnetic head including a reading element portion R and a writing element portion W. However, the present invention is also applicable to a read-only thin-film magnetic head that includes only a reading element portion R and to a write-only thin-film magnetic head including only a writing element portion W.

The thin-film magnetic head according to the present invention is applicable to a magnetic head of contact start stop (CSS) type or ramp load type.

What is claimed is:

1. A floating thin-film magnetic head including a slider that is floated from a surface of a rotating recording medium by airflow generated over the surface of the recording medium and a thin-film magnetic head element formed on an air-outflow end surface of the slider, a crown being formed on a medium-facing surface formed of the bottom surfaces of the slider and the thin-film magnetic head element so as to protrude in a section that includes an air-inflow end and an air-outflow end of the slider, wherein
the crown comprises a large-diameter crown with a large curvature radius that forms a central portion of the medium-facing surface excluding the air-inflow end and the air-outflow end, and a small-diameter crown forming portions of the medium-facing surface corresponding to the air-inflow end and the air-outflow end.

2. The thin-film magnetic head according to claim 1, further comprising a reading element portion and a writing element portion deposited in this order from the slider.

3. A method for producing a thin-film magnetic head, comprising:
a step of forming a thin-film magnetic head element on an air-outflow end surface of a slider that is floated from a surface of a rotating recording medium by airflow generated over the surface of the recording medium; and
a step of lapping that forms convex crowns on a medium-facing surface formed of the bottom surfaces of the slider and the thin-film magnetic head element in two phases, the step of lapping comprises a first lapping step that forms a first crown in a section including an air-inflow end and an air-outflow end of the slider, and a second lapping step that forms a second convex crown in the section including the air-inflow end and the air-outflow end of the slider on the same medium-facing surface in random order; and
the radii of the first crown and the second crown are different from each other.

4. The method for producing a thin-film magnetic head according to claim 3, wherein the step of lapping performed in the two phases comprises the first lapping step that forms the first convex crown having a large curvature radius on the medium-facing surface in the section including the air-inflow end and the air-outflow end of the slider, and the second lapping step that forms the second convex crown having a small curvature radius on the same medium-facing surface in the section that includes the air-inflow end and the air-outflow end of the slider where the distance between the thin-film magnetic head element having the second crown and the recording medium is larger than the distance between the thin-film magnetic head element having the first crown and the recording medium.

5. The method for producing a thin-film magnetic head according to claim 3, wherein a reading element portion and a writing element portion are deposited in this order from the slider in the step of forming the thin-film magnetic head element.

6. The method for producing a thin-film magnetic head according to claim 3, wherein the first and second lapping steps are performed on a bar having a plurality of sliders and thin-film magnetic head elements.

7. The method for producing a thin-film magnetic head according to claim 4, wherein the first lapping step and the second lapping step are performed in any order.
